(19) United States
(12) Patent Application Publication
(10) Pub. No.: US 2012/0287758 A1
(43) Pub. Date: Nov. 15, 2012

(54) Pace Clock

(76) Inventor: Yingjie Lin, El Paso, TX (US)

(21) Appl. No.: 13/107,650

(22) Filed: May 13, 2011

(51) Int. Cl. G04C 11/02

(52) U.S. Cl. 368/47

(57) ABSTRACT

The present invention relates to a pace clock and system for timing repetitive exercise, and more particularly to a pace clock and system for interval based training such as swim training to allow the swimmer predetermined periods of time to rest and recover after each individual swim within a particular set. A pace clock according to the present invention can display time in minutes and seconds; it can also display at least one additional digit which indicates the swim repeat number and/or cycle repeat number. The pace clock having a processing center, such as a micro-controller, to receive operation commands and workout plan from the master controller, such as computer and handheld device, through the transceiver. The master controller connecting with multiple pace clocks through RF or wired transceiver enables the coach to know the current status of the workout from multiple swimmers having their own workout plan.

### BACKGROUND OF THE INVENTION

1. Field of the Invention

The present invention relates to a pace clock and system for timing repetitive exercise, and more particularly to a pace clock and system for interval based training such as swim training to allow the swimmer predetermined periods of time to rest and recover after each individual swim within a particular set.

2. Description of Related Art

The pace clock allows a swimmer to perform interval sets during swimming workout. It is also a useful device in evaluating a swimmer's improvement. A typical analog pace clock has a minute hand and a second hand to indicate minutes and seconds but because they do not have programming capabilities, swimmers have to remember and calculate the repeat number, the interval times, when the last swim was started and when the next swim will be started.

Although some of the digital clock can be programmed to continuously run the workout but it only shows the count-up or count-down minutes and seconds; the digital pace clocks, such as COLORADO 4 digit pace clock with controller, PC pro digital COLORADO pace clock, and FINIS four-digit pace clock, do not display cycle repeat number or the swim repeat number. The swimmers need to remember how many swim or how many cycles have been finished. Also, the coach has no way to know what the status of the swimmer's workout is by looking at the pace clock.

Currently available pace clocks in the market, such as COLORADO pace clock controller, receive the workout plan wirelessly from the pace clock controllers, which connects to the computer to download the workout plans from Hy-Tek's Workout Manager Software program. The pace clock have training and display modes but they require additional equipment for timing input.

Therefore, there exists a need to have a pace clock that clearly displays interval time, swim repeat number, and/or cycle repeat number for swimmers and coaches to easily keep track of the workout. The pace clock should allow a user to transfer a downloaded workout plan from a computer, or a handheld device to a pace clock without the need of a specific controller or needing additional components. The invention should also have a feature that allows a plurality of pace clocks to have connections with a computer or a handheld device so that a coach can monitor the current stage of the workout practice of each swimmer having their own workout.

### SUMMARY OF THE INVENTION

One object of the present invention is to have a device that can transfer a downloaded workout program from a computer, or a handheld device.

Another object of the present invention is to have a device that can display interval time, repeat number, and/or cycle repeat number, so that the swimmers do not need to remember or calculate how many swims, how many cycles have been finished, or when the next swim should be started.

Another object of the present invention is to have a device that allows a coach to know what is the current stage of the workout and how well the swimmers performance/achievement corresponds to the given interval.

Still another object of the present invention is to have a device and system that allows a coach to monitor the progress of swimmers in multiple lanes.

Yet another object of the present invention is to have a device that allows the coach to pause/resume the clock by using handheld master or on clock switches if the coach needs to pause the workout and talk to the swimmers and resume the workout.

A pace clock according to the present invention can display time in minutes and seconds; it can also display at least one additional digit which indicates the swim repeat number and/or cycle repeat number. The interval time could be a countdown or a count-up. The cycle repeat number and the system repeat number could be a countdown or a count-up. In general, a countdown is the preferred mode for all of interval time and repeat numbers. If a dot matrix display or other text format display (such as computer monitor or TV set) are used, the swim explanation could also be displayed on the screen as “optional”. The display unit is an LED, LCD or any kind of electronics display such as an OLED, a plasma display, a CRT, etc.

In one embodiment, the clock has a receiver/transmitter unit which can have bi-direction communication capability to a master controller, such as a computer, a desk top equipment, a handheld device. In one embodiment, the receiver/transmitter is a radio frequency transceiver; in another embodiment, the receiver/transmitter is a wired connection transceiver.

The clock has a processing center, such as a micro-controller, coupling with the receiver/transmitter; the processing center receives operation commands, and workout plan from the master controller through the transceiver. The workout plan could be downloaded to the master controller (e.g. computer, handheld device, etc.) from TeamManager, TeamUnify and/or other computer software. The processing center also couples with a memory unit where the workout plan can be saved together with the clock ID number, the latter of which can be transmitted to the master controller through the processing center and transceiver.

The processing center also couples with a real time clock to receive real time setting information; the internal clock time in the real time clock can be updated/synchronized with the master controller (e.g. computer and/or handheld device, etc.). A pace clock can be started, stopped, paused, and/or resumed by a depression of a switch or by a command sent through transceiver from the master controller. When the processing center receives input from the switch or command from the master controller, it starts, stops, pauses, or resumes the pace clock. The clock has a power source, such as a battery, a solar power source, or external power supplier to power all the electronics circuit.

A pace clock system according to the present invention comprises a pace clock and a master controller, which can be a computer, a handheld electronic device, and/or desktop equipment. In one embodiment, the handheld electronic device is one of an iPhone and an iTouch. In one embodiment, the master controller may couple with multiple pace clocks and each pace clock has its own ID number so that a coach can communicate with each pace clock by using individual ID or broadcasting to all clocks. Through the master controller (a computer or a handheld device), the coach could download workout plans to each pace clock which could have its own workout plan, synchronize the clock times, start individual or all pace clocks, pause individual or all pace clocks, stop individual or all pace clocks, and resume individual or all pace clocks. In one embodiment, the processing center of the pace clock will transmit clock ID number and pace clock status (e.g. running stage, pause/resume, etc) to the master controller through transceiver. The pace clock system further comprises a router between the handheld device such as iPhone or iTouch and a plurality of pace clocks.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is an exemplary pace clock block diagram;

FIG. 2 is an example of pace clock display unit used as a regular clock;

FIG. 3 is an example pace clock display unit used as a workout pace clock and a countdown/count up timer;

FIG. 4 is an exemplary pace clock system diagram; and

FIG. 5 is an exemplary diagram of a pace clock system with router.

### DESCRIPTION OF THE PREFERRED EMBODIMENT

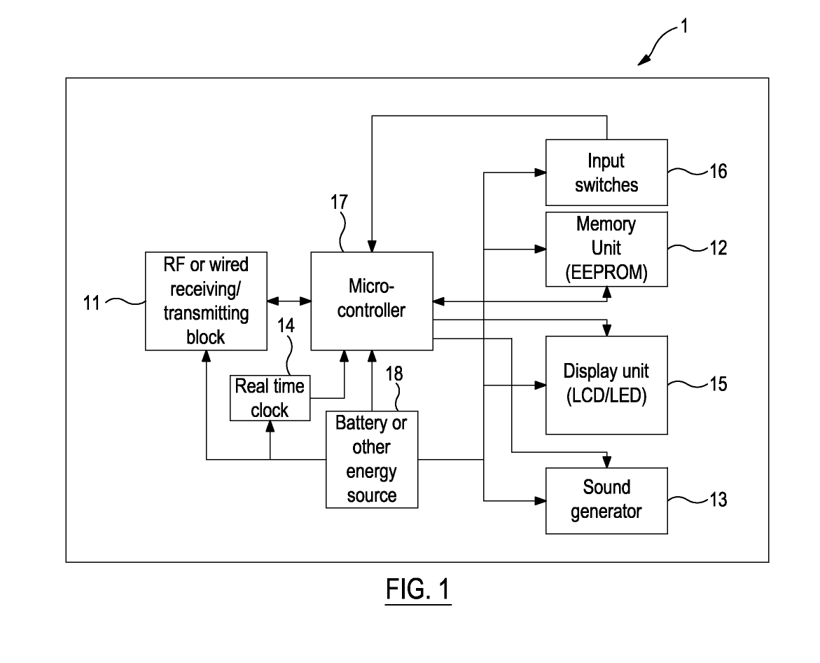

Referring to FIG. 1, there is disclosed a pace clock block diagram. The pace clock 10 comprises a receiver/transmitter 11 to receive operation commands, workout plan from a master controller 20 (not shown), which may be a computer, a laptop, a desk equipment and/or a handheld electronic device; a memory unit 12 to save clock ID number and workout plan; a sound generator 13 to generate audible sound, which is programmable to have different separation between beeps; a real time clock 14 to keep the real time with a build in calendar; a display unit 15, such as an LCD, LED, or any kind of electronics display such as an OLED, a plasma display, a CRT, etc. device, to display interval time in minutes and seconds; a plurality of switches 16, and a power source 17, which may be a battery, a solar power source, and/or external power supplier, to power all the electronic circuit.

The pace clock 10 also comprises a processing unit 18, such as micro-controller, which can communicate through the receiver/transmitter unit 11 to receive operation commands, workout plan from the master controller 20. The processing unit 18 can also receive real time setting information from the real time clock 14. The processing unit 18 may also transmit clock ID number and pace clock status (running stage, pause/resume, etc.) to the master controller 20 through receiver/transmitter 11. The processing center 18 further communicates with the memory unit 12 so that the memory center 12 will store or save the workout plan sent out by the master controller 20. The processing center 18 may also control the display unit to display in regular or pace clock mode. In addition to display regular or pace clock in minutes and seconds, the pace clock may display repeat number and/or cycle repeat number. The processing center 18 receives input from input switches 16 to start, stop, pause, and resume the pace clock. The processing center 18 controls the sound generator 13 to produce beeps of different separation.

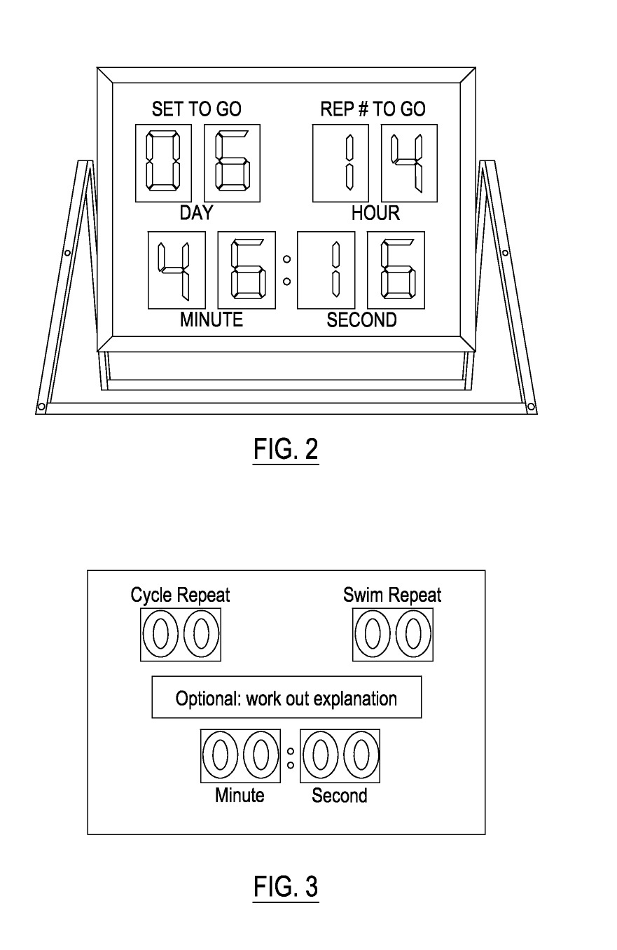

The pace clock 1 having a display unit 15 can work as a regular clock to display day, hour, minute, and seconds as shown in FIG. 2. The pace clock 1 can be used as a workout pace clock. As illustrated in FIG. 3, the pace clock 10 displays interval time on minute and seconds: MM:SS, which could be a count-up or a countdown. It also displays cycle repeat number and swim repeat number; both could be a count-up or countdown. The countdown mode is preferred for all of interval time, cycle repeat number and swim repeat number. If a dot matrix display or other text format display (such as computer monitor or TV set) are used, the swim explanation also could be displayed. To start, stop, pause, and resume workout pace simply press the clock switch 16 (not shown in FIG. 3). The switches on Pace Clock are optional. The Pace Clock nay or nay not have switches. All the input commands can be sent from the master controller. if there are switches on the Pace Clock, than some of the simple commands, such as start/stop, pause/resume, change mode from regular clock to pace clock or vise verse, could be input by pressing switch(es).

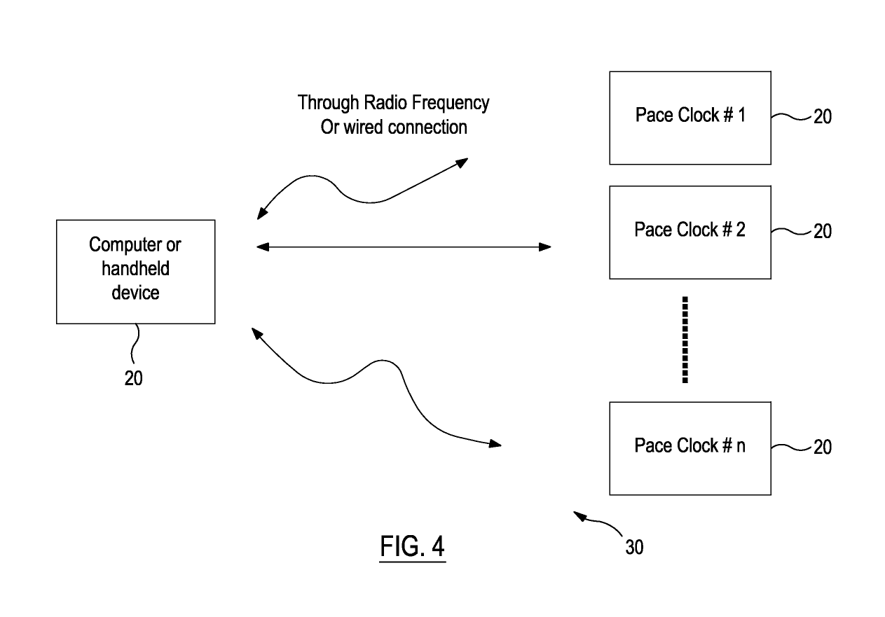

FIG. 4 illustrates a pace clock system 30 diagram. The pace clock system 30 comprises at least one pace clock 10 and a master controller 20, which can be a computer with additional radio frequency circuit, a desk equipment, a handheld electronic device such as iPhone, smart phone, etc. In order to distinguish individual clock, each clock has its own ID number. The communication between the master controller 20 and each pace clock 10 is bi-direction through radio frequency and/or wired connection. The master controller 20 can communicate with each pace clock 10 using individual ID number or broadcast to all pace clocks 10. Through the radio frequency or wired connection between the master controller 20 (e.g. a computer or a handheld device) and the pace clock 10, a user (e.g. a coach, etc.) can download workout plans, which could be generated from TeamManager, Teamunify, and/or other computer software, to each pace clock 10. Each clock 10 could have its own workout plan. The coach can synchronize the internal clock time 14 of the pace clock 10 with computer or handheld device 20. The coach can use the master controller 20 or clock switches 16 to start, pause, resume, and stop each individual or all pace clock 10 if the coach needs to pause the workout and talk to the swimmers and resume the workout.

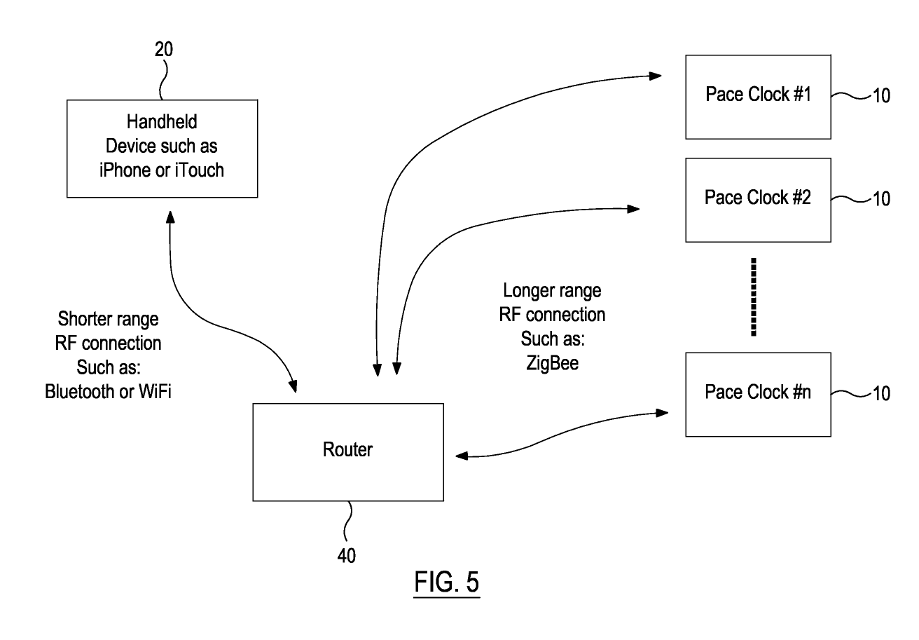

Referring to FIG. 5, there is disclosed an exemplary pace clock system with a router. The pace clock 10 can be connected with handheld device 20 such as iPhone or iTouch through the router 40.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A pace clock comprising:
(a) a receiver/transmitter unit which has bi-direction communication with a master controller;
(b) a memory unit for saving clock ID number and workout plan;
(c) a sound generator for generating audible sound;
(d) a display unit which can display time in minutes and seconds, and at least one additional digit which indicate the repeat number and/or cycle repeat number;
(e) at least one or no input switches;
(f) a real time clock for keeping the real time with a build in calendar;
(g) a processing unit which communicates with the receiver/transmitter unit and the memory unit in bi-direction, controls the sound generator and the display unit; receives input from switches and real time information from the real time clock unit; and
(h) a power source for supplying electricity to all the electronics circuit.

2. The pace clock of claim 1, wherein the receiver/transmitter unit is one of a radio frequency transceiver, a wired connection transceiver and combinations thereof.

3. The pace clock of claim 1 can work as a regular clock.

4. The pace clock of claim 1, wherein the power source is one of a battery, a solar power source, an external power supplier, and combinations thereof.

5. The pace clock of claim 1, wherein the display unit is one of an LCD, or an LED, or any kind of electronics display such as an OLED, or a plasma display, or a CRT, etc.

5. The pace clock of claim 1, wherein the processing unit is a micro-controller.

6. The pace clock of claim 1, wherein the sound generator is programmable.

7. A pace clock system comprising a pace clock of claim 1 and a master controller unit which has bi-direction communication with the receiver/transmitter unit of the pace clock.

8. The pace clock of claim 7, wherein the master controller is one of a computer, a desk top equipment, and a handheld device.

9. The pace clock of claim 7, wherein the master controller unit communicates with the pace clock in bi-direction through one of a radio frequency transceiver and a wired connection transceiver to send operation command and the workout plan to the pace clock and receive the pace clock ID number and status from the pace clock.

10. The pace clock of claim 7, wherein the master controller can communicate to each individual pace clock and/or broadcast to all pace clocks.

11. The pace clock system of claim 7 further comprising a router.

12. A pace clock system comprising:
(a) a receiver/transmitter unit which has bi-direction communication to a master controller;
(b) a memory unit for saving clock ID number and workout plan;
(c) a sound generator for generating audible sound;
(d) a display unit which can display time in minutes and seconds, and at least one additional digit which indicate the repeat number and/or cycle repeat number;
(e) at least one or no input switches;
(f) a real time clock for keeping the real time with a build in calendar;
(g) a processing unit which communicates with the receiver/transmitter unit and the memory unit in bi-direction, controls the sound generator and the display unit; receives input from switches and real time information from the real time clock unit;
(h) a power source for supplying electricity to all the electronics circuit; and
(i) a master controller unit which has bi-direction communication with the receiver/transmitter unit.

13. The pace clock of claim 12, wherein the receiver/transmitter unit is one of a radio frequency transceiver, a wired connection transceiver and combinations thereof.

14. The pace clock of claim 12, wherein the power source is one of a battery, a solar power source, an external power supplier, and combinations thereof.

15. The pace clock of claim 12, wherein the display unit is one of an LCD, an LED, an LCD or any kind of electronics display such as an OLED, or a plasma display, or a CRT, etc.

15. The pace clock of claim 12, wherein the processing unit is a micro-controller.

16. The pace clock of claim 12, wherein the sound generator is programmable.

17. The pace clock of claim 12, wherein the master controller is one of a computer, a desk top equipment, and a handheld device.

18. The pace clock of claim 18, wherein the master controller unit communicates with the pace clock in bi-direction through one of a radio frequency transceiver and a wired connection transceiver to send operation command and the workout plan to the pace clock and receive the pace clock ID number and status from the pace clock, the master controller can communicate to each individual pace clock and/or broadcast to all pace clocks.
